(19) United States
(12) Patent Application Publication
(10) Pub. No.: US 2013/0292528 A1
(43) Pub. Date: Nov. 7, 2013

(54) HOIST ASSEMBLY FOR WALL MOUNTED OBJECTS

(71) Applicant: Fernando Davila, Oakland Park, FL (US)

(72) Inventor: Fernando Davila, Oakland Park, FL (US)

(21) Appl. No.: 13/461,243

(22) Filed: May 1, 2012

(51) Int. Cl. F16M 13/02

(52) U.S. Cl. 248/201; 248/205.1

(57) ABSTRACT

A wall hoist assembly for lifting, adjusting, and supporting an object onto a mounting surface, such as a vertical wall. A pair of wall hoist assemblies attach to both ends of the wall mounted object to create complimentary support for each other. The wall hoist assembly includes a cable for engaging three pulleys and transmitting a tension force along its longitudinal breadth, with each pulley sharing the weight of the wall mounted object, and the cable transmitting a tension force along the whole wall hoist assembly. The cable engages the three pulleys in such a manner that less work is needed to lift, adjust, and support heavy objects onto the wall. A first pulley includes a locking member that allows the cable to be locked into a stationary position. A second pulley attaches to the wall, and a third pulley attaches to the object. The three pulleys work together.

### FIELD OF THE INVENTION

The present invention relates generally to a hoist assembly for wall-mounted objects, and more particularly relates to a wall hoist assembly that includes a pulley system that transmits a tension force along one or more cables so that the weight of the wall mounted object is shared between multiple pulleys to more easily lift, support, and level the object on a wall, and the pulleys are then hidden by the object.

### BACKGROUND OF THE INVENTION

Large portraits, full size mirrors, flat screen televisions, and other similar heavy or bulky wall mounted objects are often utilized to enhance a wall and create a unique, aesthetic affect. Heavy and/or large wall mounted objects have always been popular, especially in museums and mansions. Unlike simple pictures or clocks though, positioning and properly leveling heavy or large objects onto a wall requires special procedures and equipment. The weight is the obvious first issue to consider. While it may be possible to simply screw a few fasteners into half-inch drywall to hang a lighter object, a heavier object would eventually pull the fasters out of the relatively soft drywall. Also, since the heavier object creates greater friction positioning onto the wall, damage to the wall or overlaying paint is a problem. Furthermore, leveling remains a difficult and tedious task. Two people are often required to level a heavy object on a wall, which can be cumbersome, inefficient, and lead to damaging the wall or object.

To solve the above-described problems and to protect the wall and heavy or large object, locating the framing stud is a necessary first step. A stud finder is a handheld device used to determine the location of wood and metal framing studs. Once the stud has been located, it provides sufficient support for most heavy objects. But this still does not resolve the issue of lifting, securing, and leveling the heavy object onto the wall. To fasten the object to the wall, special wall fasteners capable of bearing the weight of the object without ruining the walls are utilized. Cleats will bear the heaviest weight, followed by toggle bolts, molly bolts, plastic wall anchors, double-screw picture hangers, double-nail hangers, single-screw hangers and single-nail hangers. Often, creating an additional support—such as a ledge, shelf, hook or wall mount—if the object is too heavy for any of the fasteners, provides additional support.

Moreover, the most common method of raising the object to the desired position simply involves two people lifting the object while a third person eyeballs the object to verify the correct height and level. However, if three people are not available, this technique will not work. Also, the “eyeball” test does not ensure a perfect horizontal position. Furthermore, it is difficult to truly gauge the position of the object while the two people are partially blocking the ends. It is also problematic that lifting a very heavy object can cause damage to the lifter's back, especially while standing in an awkward position along the wall.

Moreover, an instrument designed to indicate whether a surface is horizontal (level) or vertical (plumb) is a bubble level. The bubble level features a slightly curved glass tube which is incompletely filled with a liquid, usually a colored spirit or alcohol, leaving a bubble in the tube. At slight inclinations the bubble will travel away from the center position, which is usually marked in some manner. The bubble level is efficacious in determining whether the object is level. However, if the object is not level, the object must then be repositioned and lifted from the start again. There is no option to make slight adjustments.

Therefore, a need exists to overcome the problems with the prior art as discussed above.

### SUMMARY OF THE INVENTION

The invention provides a hoist assembly for wall mounted objects that overcomes the hereinafore-mentioned disadvantages of the heretofore-known devices and methods of this general type and that utilizes a wall hoist assembly that includes a pair of multi-pulley subassemblies for transmitting a tension force along a pair of cables so that the weight of a wall mounted object is shared between the subassemblies (typically two) for more easily lifting, leveling, and supporting heavy or simply bulky objects onto a wall.

With the foregoing and other objects in view, there is provided, in accordance with the invention, a wall hoist assembly for lifting, leveling, and supporting at least one object onto a mounting surface, such as a vertical wall. The wall hoist assembly includes a first and a second cable for engaging a first and a second pulley subassembly and transmitting a tension force along each cable's longitudinal breadth. Those skilled in the art can appreciate that the cable can be a nylon rope, aluminum cord, plastic rod or the like and is not limited to any specific material. Each cable has a distal end that is grasped by a user for adjusting one side of the object being supported. In one embodiment, the cable distal end is pulled in a first side direction to lock the cable into a stationary position. The cable distal end is also pulled towards a second direction to allow the cable to move freely along the wall hoist assembly. The cable is further defined by a cable proximal end for securing the cable to the wall hoist assembly.

The wall hoist assembly also includes a pair of tilt pulley assemblies adapted to rotatably engage the pair of cables. The pair of tilt pulley assemblies each include a multi-directional tilt sheave for engaging the cable. Each tilt pulley assembly further includes a tilt axle for rotatably engaging the tilt sheave. Each tilt pulley assembly further includes a locking member assembly for locking the cable into a stationary position, which allows the cable to slide into the first direction, and selectively prevents the cable from sliding into the second direction. Referring to one of the subassemblies, the locking member assembly also includes a first support member for engaging the cable and pressing the cable against a second support member, thereby locking the cable. The locking member assembly further includes a spacer. The spacer is defined by a spacer aperture end, which includes a spacer aperture for the cable to pass through. The spacer is also defined by a spacer locking end for pressing against the first support member.

The cable traverses the wall hoist assembly, but can also be locked into a stationary position after the lifting and adjusting of the object is complete. In one embodiment, urging the cable distal end towards the first direction causes the spacer locking end to pivotally press against the first support member, causing the first support member to press the cable against the second support member to create a compression force between the spacer and the second support member that locks the cable into a stationary position. This position is desirable after the object is fully lifted and leveled. Further, in the same embodiment, urging the cable distal end towards the second direction causes the spacer aperture end to shift in a correlating direction, causing the spacer locking end to pivotally move away from the first support member, causing the first support member to move away from the cable, causing the cable to move away from the second support member thereby removing the compression force between the spacer and the second support member, and finally allowing the cable to traverse along the wall hoist assembly. This position is desirable for lifting and adjusting the object, such as during leveling.

A mounting surface pulley assembly is another pulley subassembly that is part of the wall hoist assembly. The mounting surface pulley assembly is adapted to rotatably engage the cable, and includes a mounting aperture for fastening the mounting surface pulley assembly to the mounting surface. Fasteners such as screws, bolts, nails, adhesives, and the like pass through the mounting aperture to secure the mounting surface pulley assembly to the mounting surface. The mounting surface pulley assembly further includes a multi-directional mounting sheave for engaging the cable and a mounting axle for rotatably engaging the mounting sheave.

An object mounting pulley assembly is another pulley subassembly in the wall hoist assembly and is adapted to rotatably engage the cable. The object mounting pulley assembly includes an object aperture for fastening the object mounting pulley assembly to the at least one object. In one embodiment, fasteners such as screws, bolts, nails, adhesives, and the like are utilized. The object can include a large portrait in a museum, a large mirror, a flat screen television, and similar large ornamental and functional objects that hang on walls. The object mounting pulley assembly further includes a multi-directional object sheave for engaging the cable and an object axle for rotatably engaging the object sheave.

At least one sleeve member is positioned inside the tilt pulley assembly for providing stability to the cable and minimizing tilt to the wall hoist assembly. The sleeve member provides a rigid longitudinal frame support at a point of high stress and tension in the tilt pulley assembly.

In one embodiment, a pair of wall hoist subassemblies is mounted adjacent from each other on the mounting surface. Each wall hoist subassembly attaches to an end of the object to create complimentary support for each other. As one wall hoist subassembly adjusts one end of the object, the other wall hoist subassembly can simultaneously adjust the other end of the object accordingly, whereby one end of the object rises to the desired height on the wall, becoming level with the other end.

In accordance with another feature, an embodiment of the present invention includes three separate pulleys simultaneously engaging the cable. The synergetic effect of the three pulleys sharing the weight of the object creates sufficient tension force on the cable to facilitate the lifting and adjusting of the object onto the wall. Those skilled in the art can appreciate that utilizing more than three pulleys with the wall hoist assembly amplifies the tension force effect on the cable, creating for easier lifting and adjusting of the object.

In one embodiment, the first support member located in the locking member assembly includes a plurality of locking member serrated members projecting outwardly for providing increased meshing force when pressing the cable against the second support member to lock the cable into a stationary position. In the same embodiment, the spacer locking end located in the locking member assembly includes a plurality of spacer serrated members projecting outwardly for providing increased meshing force against the first support member. Since the spacer locking end shifts in correlation to the directional movement of the distal cable end, the extra grip that the spacer serrated members provide is efficacious towards creating a tighter fit with the first support member. Both the locking member serrated members and the spacer serrated members can be teeth, such as found in a gear.

In accordance with a further feature of the present invention, after the object is fully lifted and adjusted into a final position, the cable distal end and the mounting surface pulley assembly conceal behind the object. Since the cable distal end attaches to the tilt pulley assembly, it rotates behind the object. As the object rises along the wall, it eventually covers the entire mounting surface pulley assembly.

In accordance with the present invention, a method for lifting and adjusting the object onto the mounting surface is described. Initially, a desired location to hang the object on the mounting surface is identified. A wall hoist subassembly is positioned at the desired height for the object. The mounting surface pulley assembly is fastened to the mounting surface. Often the mounting surface is a vertical wall. A variety of fasteners can be utilized to secure the mounting surface pulley assembly to the mounting surface. In one embodiment, nails, bolts, adhesives, screws, and the like pass through the mounting aperture and through a stud frame behind the wall. A second wall hoist subassembly is similarly attached onto the mounting surface, parallel to the first wall hoist subassembly and at approximately the same height as the first wall hoist subassembly. However, the two wall hoist subassemblies are spaced apart from each other at a distance that correlates with the distance between the ends of the object. The two object mounting pulley subassemblies are then secured to the back of the object, in proximity to each end of the object. Enough slack in the cable should be made available so that the object can rest on the ground while the object mounting pulley subassemblies are lowered and then attached to the back of the object. The cord distal ends from both wall hoist subassemblies are then pulled straight down to lift the object up along the wall. The wall hoist assembly tilts inwardly as the object lifts due to the increase in tensile force along the cable. However, the sleeve member, which provides a rigid framework for the cable through the tilt pulley assembly, minimizes the tilting effect.

After the object is lifted to a desired height, both cable distal ends should be pulled towards the first direction. In one embodiment the first direction is outward from the object. This directional urging of the cable distal end actuates the locking member by causing the spacer aperture end to shift in a correlating direction, which causes the spacer locking end to pivotally press against the first support member, thereby causing the first support member to press the cable against the second support member, creating a compression force between the spacer and the second support member that locks the cable into a stationary position. The object should be inspected to verify that it securely attaches to the wall hoist assembly. Similarly, the wall hoist assembly should be checked to verify that it securely attaches to the object, and to the mounting surface.

Furthermore, in the same embodiment if it is desirable to lower the object, readjust the height of the object, or perform other leveling adjustments, it is possible to pull the cable distal end towards the second direction, e.g., inwardly towards the object. The pulling action towards the second direction results in the first support member moving away from the cable, causing the cable to move away from the second support member, thereby removing the compression force between the spacer and the second support member, and finally allowing the cable to traverse along the wall hoist assembly.

At this point, both wall hoist assemblies will be tilted inwardly. The heavier the object, the greater the angle of the tilt. The cable distal end will, however, still extend down from the tilt pulley assembly and be accessible. At this point, the object should be inspected to verify that it is level. If not, the cable distal end that correlates with the lower end of the object should be pulled towards the second direction so as to release the cable for further adjustments. Then, the same cable distal end is slowly pulled until the object is level. The cable distal end is then pulled towards the first direction to lock the cable into the stationary position. Finally, since the cable distal end passes through the tilt pulley assembly, it pivots parallel to the wall, concealing behind the object so that the complete wall hoist assembly is not visible after the object is fully lifted and adjusted. To lower the object, both cable distal ends pivot out from behind the object, moving the cable distal end towards the second direction releases the cable, and the weight of the object is allowed to slowly fall, while the cable slowly releases.

In accordance with another feature, an embodiment of the present invention does not utilize a multi-pulley system to engage the cable. Rather, the cable passes through a surface mounting assembly and a locking member. The surface mounting assembly is adapted to slidably engage the cable, and includes a mounting aperture for fastening the surface mounting pulley to the mounting surface. The surface mounting pulley assembly further includes a substantially arched hub member for slidably engaging the cable. The hub member includes a channel, wherein the cable passes through the channel in the hub member. The locking member is utilized for locking the cable into a stationary position. The locking member includes a locking aperture for the cable to pass through, and a plurality of serrated members for gripping the cable, wherein tilting the cable in a first direction causes the locking member to grip the cable and tilting the cable in a second direction causes the locking member to release the cable. The gripping effect of the locking member is based on friction between the serrated members and the cable.

In accordance with yet another feature, an embodiment of the wall hoist assembly includes more than three pulleys.

In accordance with a further feature of the present invention, the wall hoist assembly is portable, lightweight, easy to store, and durable enough to support wall mounted objects heavier than one hundred pounds.

In accordance with an embodiment of the present invention, a wall hoist assembly includes an opposing pair of surface mounting pulley assemblies adapted to mechanically couple to a vertical surface, an opposing pair of object mounting pulley assemblies adapted to mechanically couple to rear surface of an object, an opposing pair of cables, each one coupling one of the pair of surface mounting pulley assemblies to one of the opposing pair of object mounting pulley assemblies, an opposing pair of tilt pulley assemblies, each tilt pulley assembly being coupled to one of the opposing pair of cables in a selectively slidable and selectively lockable relationship and located between one of the pair of surface mounting pulley assemblies and one of the opposing pair of object mounting pulley assemblies, wherein each of the opposing pair of tilt pulley assemblies includes a pulley system that translates a force applied to one of the opposing pairs of cables in a first direction into a force that moves one of the pair of surface mounting pulley assemblies in a direction toward one of the opposing pair of object mounting pulley assemblies, translates a force applied to one of the opposing pairs of cables in a second direction into a force that moves one of the pair of surface mounting pulley assemblies in a direction away from one of the opposing pair of object mounting pulley assemblies, and locks a respective one of the cables into a static position so that a distance between the one of the pair of surface mounting pulley assemblies and the one of the opposing pair of object mounting pulley assemblies remains fixed.

In accordance with an additional feature of the present invention, the object is larger than a distance between the pair of opposing surface mounting pulley assemblies when the pair of surface mounting pulley assemblies are coupled to the vertical surface so that the object hides the pair of surface mounting pulley assemblies from view.

In accordance with an yet another feature of the present invention, the opposing pair of surface mounting pulley assemblies are adapted to be mechanically coupled to a vertical surface with at least one of a nail and a screw.

In accordance with one more feature of the present invention, a track is adapted to be mounted to and couple the opposing pair of surface mounting pulley assemblies to the vertical surface and the opposing pair of surface mounting pulley assemblies are slidably engaged with the track and selectively horizontally positionable along the track.

In accordance with a mode of the invention, a method for mounting an object to a mounting surface includes the step of providing at least two wall hoist subassemblies, each subassembly including a cable, a surface mounting pulley assembly coupled to the cable, an object mounting pulley assembly coupled to the cable, and a tilt pulley assembly coupled to the cable between the surface mounting pulley assembly and the object mounting pulley assembly. The method further includes coupling the at least two surface mounting pulley assemblies to the mounting surface in an opposing arrangement, coupling the at least two object mounting pulley assemblies to a rear surface of the object in an opposing arrangement, and selectively applying a pulling force to one end of each of the at least two cables to cause the at least two object mounting pulley assemblies to move closer to the at least two surface mounting pulley assemblies.

In accordance with yet another mode, the method includes the step of selectively applying a pulling force to at least one of the at least two cables to cause the object to be mounted on the mounting surface in a level position.

In accordance with a further mode, the method includes the steps of coupling a track to the mounting surface, coupling the at least two surface mounting pulley assemblies to the track, and selectively translating the object along the mounting surface by sliding the at least two surface mounting pulley assemblies along the track.

Although the invention is illustrated and described herein as embodied in a Hoist Assembly for Wall Mounted Objects, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the cable.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of a wall hoist assembly disengaged from an object, in accordance with the present invention;

FIG. 2A is an elevational side view of a subassembly of the wall hoist assembly of FIG. 1 in accordance with the present invention;

FIG. 2B is a sectioned view of the mounting surface pulley assembly of the subassembly of the wall hoist assembly of FIG. 2A;

FIG. 2C is a sectioned view of the tilt pulley assembly of the subassembly of the wall hoist assembly of FIG. 2A showing a locking member in a locked position and preventing movement of the cable in one lateral direction;

FIG. 2D is a sectioned view of the object mounting pulley assembly of the subassembly of the wall hoist assembly of FIG. 2A;

FIG. 3A is an elevational side view of the subassembly of FIG. 2A showing the locking member in an unlocked position so that the cable can move in two lateral directions and a track for mounting and horizontally translating the subassembly, as desired;

FIG. 3B is a sectioned view of the unlocked tilt pulley assembly of FIG. 3A;

FIG. 4 is a downward looking perspective view of the tilt pulley assembly of FIG. 3.

FIG. 5 is a process flow diagram showing a method of mounting an object to a surface by using the wall hoist assembly of FIG. 1, in accordance with the present invention;

FIG. 6 is an elevational view of the wall hoist assembly of FIG. 1 coupled to a surface with the subassemblies being a different heights and the object separate from and unattached to the assembly, in accordance with the present invention;

FIG. 7 is an elevational view showing the object of FIG. 6 coupled to the wall hoist assembly of FIG. 6 by the object mounting pulley assemblies and being partially lifted into place by a longitudinal force being applied to the assembly cables, in accordance with the present invention;

FIG. 8 is an elevational view showing the object of FIG. 6 coupled to the wall hoist assembly of FIG. 6 by the object mounting pulley assemblies and being fully lifted into place and leveled by the wall hoist assembly and the cables being locked into place and hidden behind the object, in accordance with the present invention;

FIG. 9 is an elevational view of a wall hoist assembly with a clamping locking member in an open position that allows the cable to slide therethrough, in accordance with the present invention; and

FIG. 10 is an elevational view of the wall hoist assembly of FIG. 9 with a clamping locking member in a closed position that prevents the cable from sliding therethrough, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient three-pulley wall hoist assembly 100 that creates a tension force along a cable 106 to more easily lift, adjust, and support heavy objects 102 onto a mounting surface 104. Embodiments of the invention provide a tilt pulley assembly 112 that locks the cable 106 into a stationary position. In addition, embodiments of the invention provide a mounting surface pulley assembly 114 for securing the wall hoist assembly 100 to a mounting surface 104, such as a vertical wall. In addition, embodiment of the present invention provides an object mounting pulley assembly 116 for securing the wall hoist assembly 100 to the object 102.

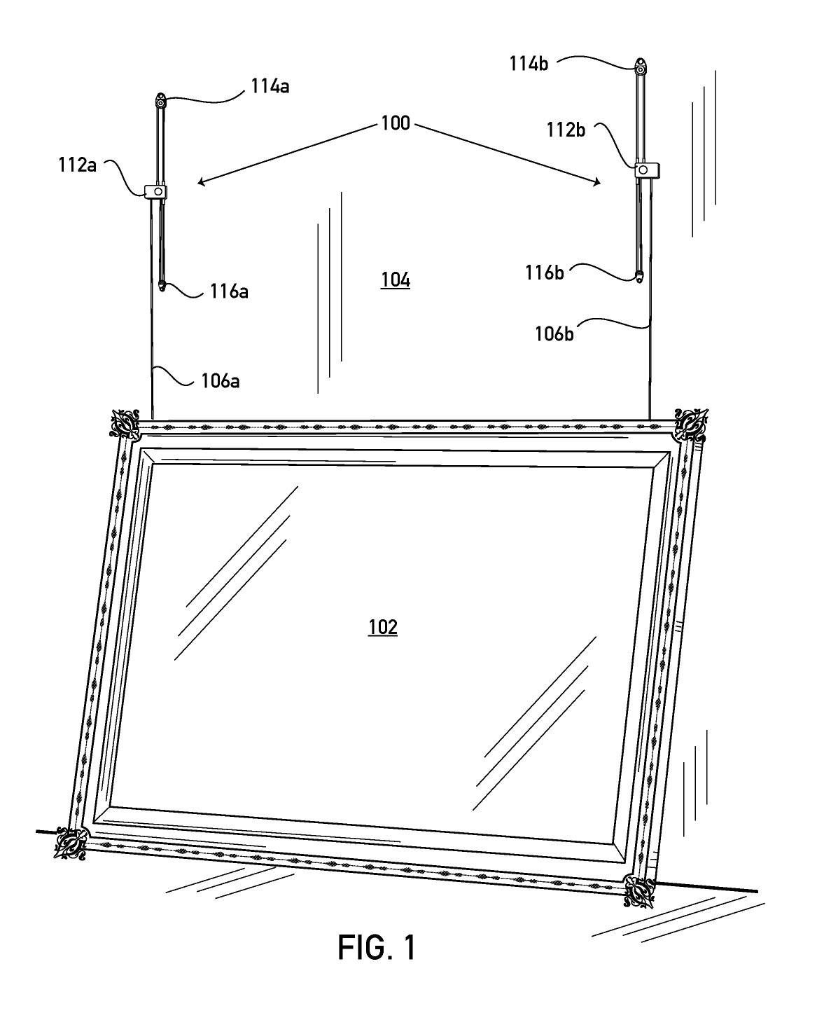

Referring now to FIG. 1, one embodiment of the present invention is shown in a perspective view. FIG. 1 shows several advantageous features of the present invention, but, as will be described below, the invention can be provided in several shapes, sizes, combinations of features and components, and varying numbers and functions of the components. The first example of a wall hoist assembly 100, as shown in FIG. 1, includes a pair of cables 106a and 106b, a pair of tilt pulley assemblies 112a and 112b, a pair of mounting surface pulley assemblies 114a and 114b, and a pair of object mounting pulley assemblies 116a and 116b, which, as will be explained in detail below, will be used to couple an object 102 to a mounting surface 104.

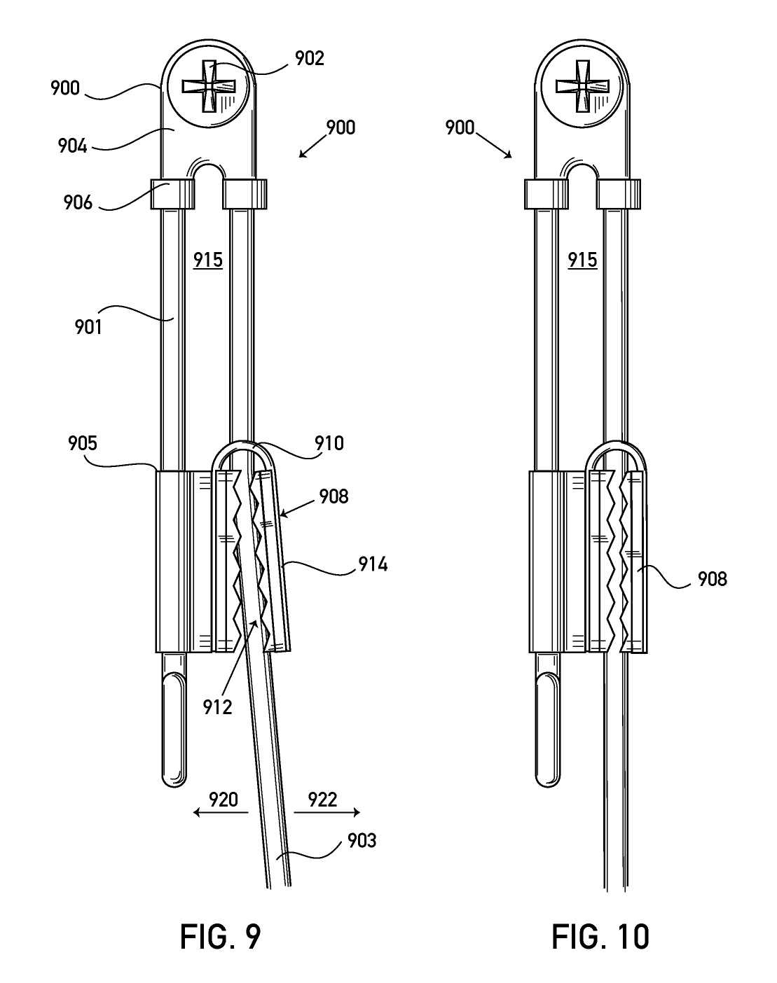

The wall hoist assembly 100 includes a three-pulley system 112, 114, 116 that shares the weight of the object 102 and transmits a tension force along the pair of cables 106a and 106b, so that the weight of the object 102 is more easily lifted, adjusted, and supported (Shown in FIGS. 9-11). A locking member assembly 204 secures the pair of cables 106a and 106b into a stationary position after the object 102 is fully lifted and leveled. The object 102 advantageously conceals the wall hoist assembly 100 from view. Each side of the wall hoist assembly 100 attaches to a corresponding side of the object 102 to create complimentary support for each other. As one side of the wall hoist assembly 100 adjusts one end of the object 102, the opposing side of the wall hoist assembly 100 simultaneously adjusts the other end of the object 102 accordingly, whereby one end of the object 102 rises to the desired height on the mounting surface 104, becoming level with the other end.

Referring now to just one of the wall hoist assembly 100 subassemblies (a and b), the wall hoist assembly 100 includes a cable 106 for engaging the three-pulley system 112, 114, 116 and transmitting a tension force along its longitudinal breadth. In one embodiment, the cable 106 engages the three-pulley system 112, 114, 116, with each pulley 112, 114, 116 sharing the weight of the object 102, and cable 106 transmitting a tension force along the wall hoist assembly 100. The cable 106 engages the three-pulley system 112, 114, 116 in such a manner that less work is needed to lift, adjust, and support heavy objects 102 onto the mounting surface 104. Those skilled in the art can appreciate that the cable 106 can be a rope, e.g., nylon, aluminum cord, plastic or other materials. The cable 106 is defined by a cable distal end 108 for lifting and adjusting the object 102. The cable 106 is further defined by a cable proximal end 110 for securing the cable 106 to the wall hoist assembly 100.

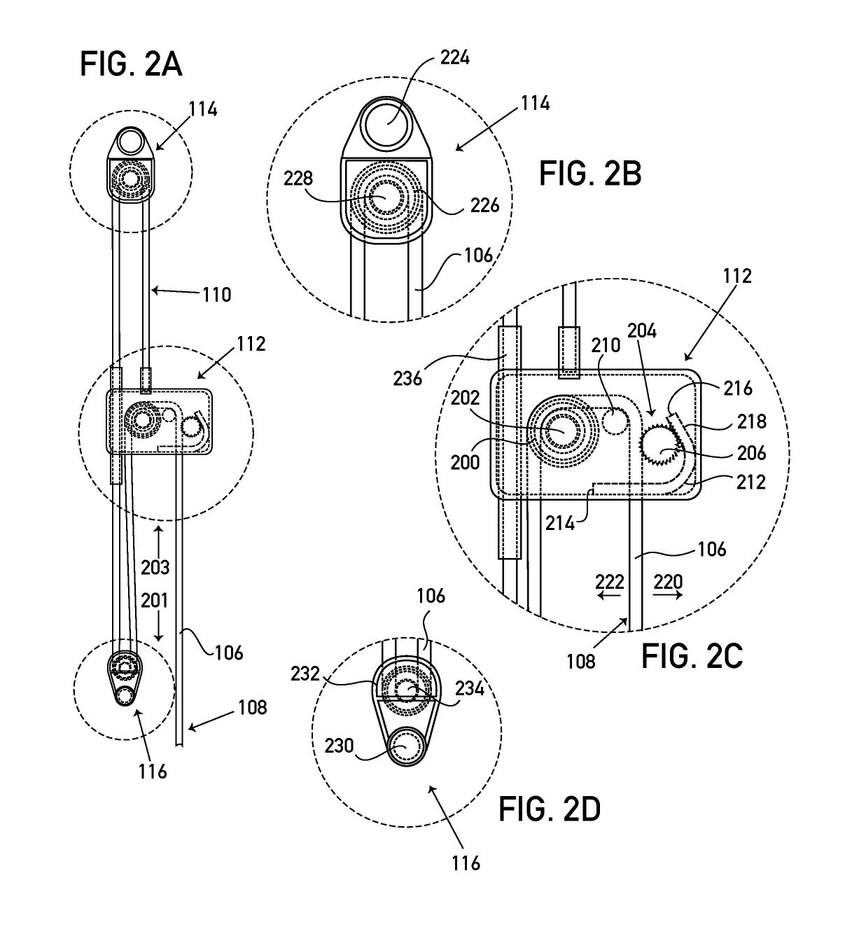

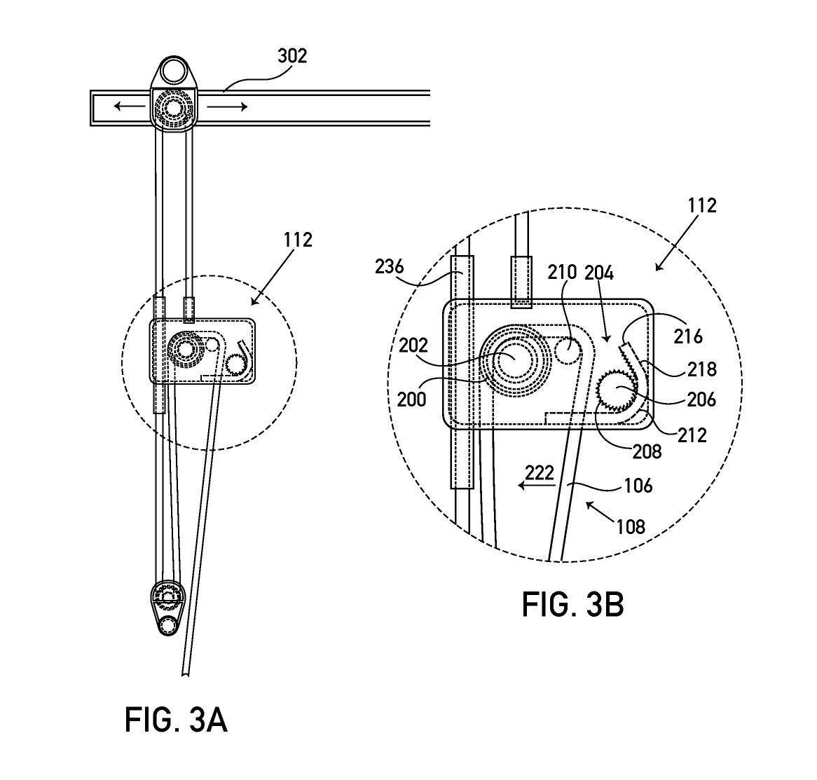

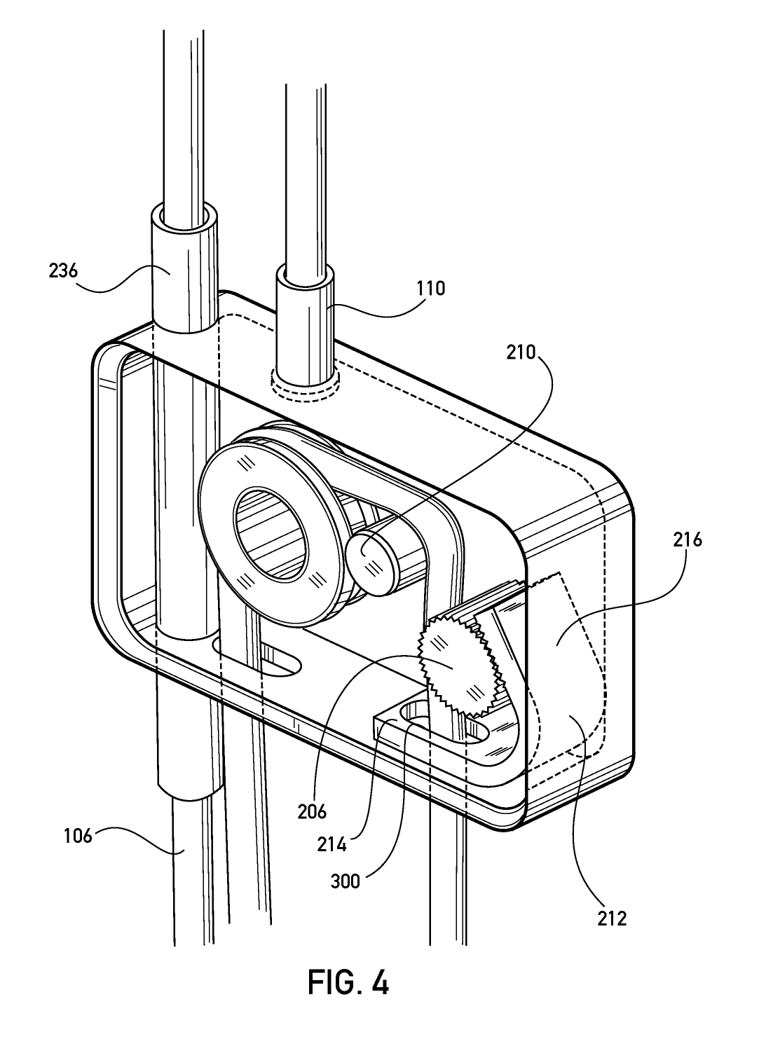

A tilt pulley assembly 112 is shown in detail in FIG. 2 and is adapted to rotatably engage the cable 106. The tilt pulley assembly 112 includes a multi-directional tilt sheave 200 for engaging the cable 106. The tilt pulley assembly 112 further includes a tilt axle 202 for rotatably engaging the tilt sheave 200. The tilt pulley assembly 112 further includes a locking member assembly 204 for locking and unlocking the cable 106 into and from a stationary position. The locking member assembly 204 allows the cable 106 to slide in a first direction 201, and selectively prevents the cable 106 from sliding in a second direction 203. The locking member assembly 204 also includes a first support member 206 for pressing the cable 106 against a second support member 210. In one embodiment, the first support member 206 includes a plurality of support member serrated members 208 projecting outwardly for providing increased meshing force against the cable 106 while pressing the cable 106 against the second support member 210. The locking member assembly 204 further includes a spacer 212. The spacer 212 is defined by a spacer aperture end 214, which includes a spacer aperture 300 (shown in FIG. 3) for the cable 106 to pass through. The spacer 212 is also defined by a spacer locking end 216, which is angled toward and causes the first support member 206 to exert pressure against the second support member 210. In one embodiment, the spacer locking end 216 includes a plurality of spacer serrated members 218 projecting outwardly for providing increased meshing force against the first support member 206 to increase grip.

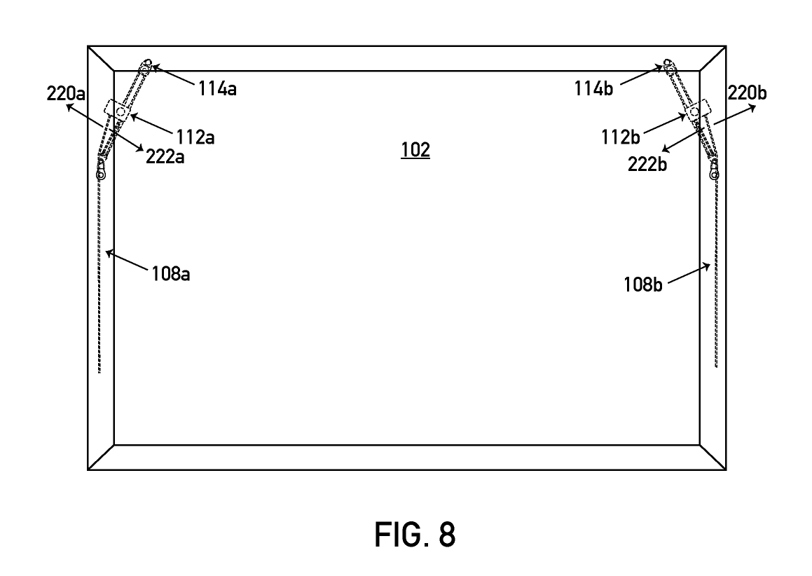

The cable 106 traverses the wall hoist assembly 100, but can also be locked into a stationary position after the lifting and adjusting of the object 102 is complete (Shown in FIG. 8). Urging the cable distal end 108 towards a first direction 220 causes the spacer aperture end 214 to shift in a correlating direction, which causes the spacer locking end 216 to pivotally press against the first support member 206, causing the first support member 206 to press the cable 106 against the second support member 210 to create a compression force between the spacer 212 and the second support member 210. This action locks the cable 106 into a stationary position. The locked position is desirable for the cable 106 after the object 102 is fully lifted and leveled onto the mounting surface 104.

Further, in the same embodiment, urging the cable distal end 108 towards a second direction 222 and slightly temporarily in the downward direction 201 causes the first support member 206 to fall downward and move away from the first support member 206 and the cable 106. This position is shown in FIG. 3. This movement removes the compression force between the spacer 212 and the second support member 210 and allows the cable 106 to traverse along the wall hoist assembly 100. This position is desirable for lifting and adjusting the object 102, such as during leveling.

At least one sleeve member 236 is located inside the tilt pulley assembly 112 for providing stability against the cable 106 and minimizing tilt of the tilt pulley assembly 112. The sleeve member 236 provides a rigid longitudinal frame support at a point of high stress and tension in the tilt pulley assembly 112.

FIG. 3 provides a downward-looking perspective view of the tilt pulley assembly 112.

The mounting surface pulley assembly 114, also shown in detail in FIG. 2, is a part of the wall hoist assembly 100. The mounting surface pulley assembly 114 is adapted to rotatably engage the cable 106, and includes a mounting aperture 224 for fastening the mounting surface pulley assembly 114 to the mounting surface 104. Fasteners, such as screws, bolts, nails, adhesives, and the like pass through the mounting aperture 224 to secure the mounting surface pulley assembly 114 to the mounting surface 104. The mounting surface pulley assembly 114 further includes a multi-directional wheel 226 for engaging the cable 106. The mounting surface pulley assembly 114 further includes a mounting axle 228 for rotatably engaging the wheel 226.

The object mounting pulley assembly 116, also shown in FIG. 2, is the third pulley in the wall hoist assembly 100, and is adapted to rotatably engage the cable 106. The object mounting pulley assembly 116 includes an object aperture 230 for fastening the object mounting pulley assembly 116 to the at least one object 102. In one embodiment, fasteners such as screws, bolts, nails, adhesives, and the like are utilized. The object 102 can include a large portrait in a museum, a large mirror, a flat screen television, and similar ornamental and functional objects, regardless of size, that hang on the mounting surface 104, e.g., a wall. The object mounting pulley assembly 116 further includes a multi-directional wheel 232 for engaging the cable 106. The object mounting pulley assembly 116 further includes an object axle 234 for rotatably engaging the wheel 232.

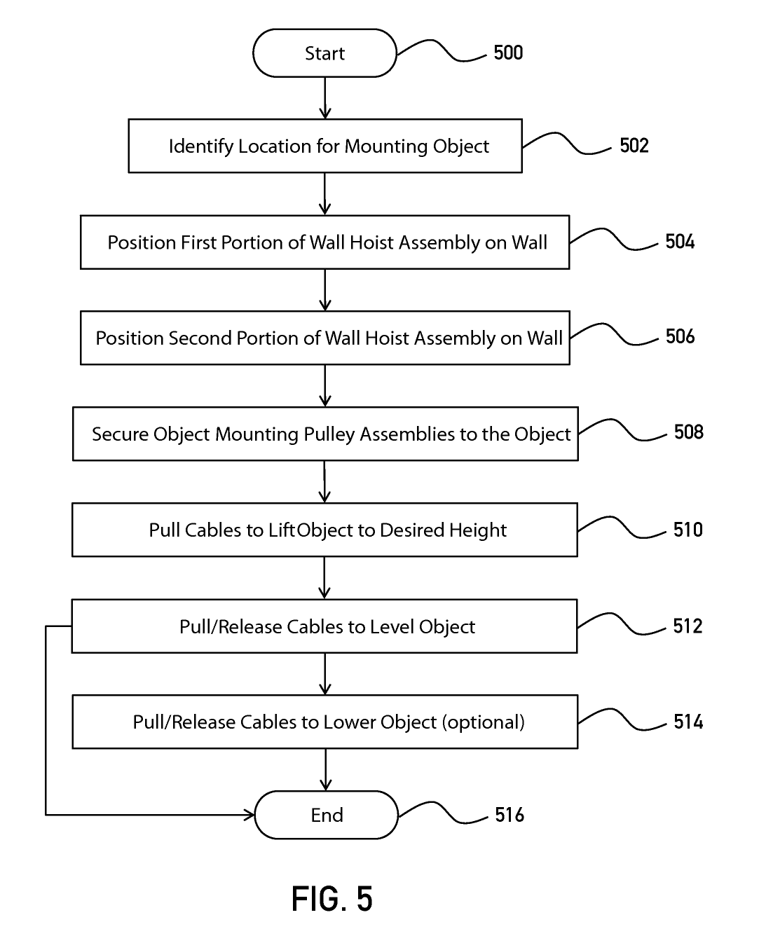

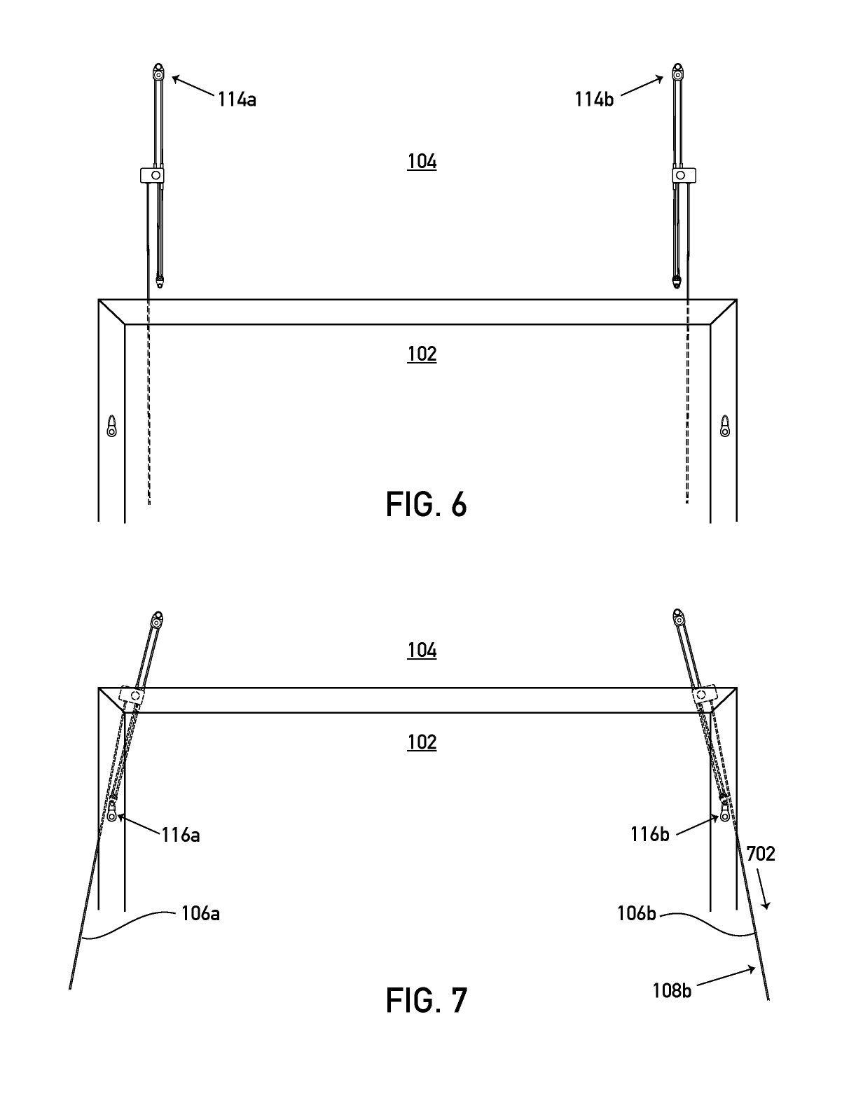

In accordance with the present invention, a method for lifting and adjusting the object 102 onto the mounting surface will now be described in conjunction with the process flow diagram of FIG. 5 and illustrated in FIGS. 6-8. Initially, in step 502 of FIG. 5, a desired location to hang the object 102 on the mounting surface 104 is identified. Next, in step 504, and as shown in FIG. 6, a first portion of wall hoist assembly 100 is positioned at the desired height for the object 102. Specifically, the first mounting surface pulley assembly 114a is fastened to the mounting surface 104. Often the mounting surface 104 is a vertical wall. A variety of fasteners can be utilized to secure the mounting surface pulley assembly 114a to the mounting surface 104. In one embodiment, nails, bolts, adhesives, screws, and the like pass through the mounting aperture 224 and through a stud frame behind the wall. In step 506, the second mounting surface pulley assembly 114b is similarly attached onto the mounting surface 104, parallel to the first wall hoist assembly 100 and at approximately the same height as the first mounting surface pulley assembly 114a. However, advantageously, unlike prior-art object hanging devices, it is not necessary to attach the two pulley subassemblies 100a and 100b at exactly the same height as each other. As will be explained below, any differences in height can be easily accommodated after the object 102 is suspended. The pair of mounting surface pulley assemblies 114 are spaced apart from each other at a distance that correlates with the distance between the ends of the object 102.

Next, in step 508, and as shown in FIG. 7, the pair of object mounting pulley assemblies 116a and 116b are secured to the back of the object 102. Enough slack in the pair of cables 106a and 106b should be made available so that the object 102 can rest on the ground while the pair of object mounting pulley assemblies 116a and 116b is lowered and then attached to the back of the object 102.

In step 510, and as shown by arrow 702 in FIG. 7, the cable distal ends 108 from each side of the wall hoist assembly 100 are then pulled in a downward direction to lift the object 102 up (see FIG. 8) along the mounting surface 104. After the object 102 is lifted to a desired height, in step 512, both cable distal ends 108a and 108b are pulled towards their locking direction 220a and 220b, respectively, as shown in FIG. 8. This directional urging of the cable distal ends 108 actuates the locking member assemblies 204 by causing the first support member 206 to move upward and thereby press the cable 106 against the second support member 210. This creates a compression force between the spacer 212 and the second support member 210 that locks the cable 106 into a stationary position. The object 102 can then be inspected to verify that it is securely attached to the wall hoist assembly 100. Similarly, the wall hoist assembly 100 can be checked to verify that it is securely attached to the object 102, and to the mounting surface 104.

Furthermore, in the same embodiment, if it is desirable to release the cable 106 to readjust the height of the object 102 or perform other adjustments, it is possible, in step 514, to pull the cable distal ends 108a and 108b towards the second directions 222a and 222b, respectively. The pulling action downward and towards the second direction 222 causes the first support member 206 to move away from the cable 106, allowing the cable 106 to move away from the second support member 210 thereby removing the compression force between the spacer 212 and the second support member 210, and finally allowing the cable 106 to traverse along the wall hoist assembly 100.

At this point, the object 102 can be inspected to verify that it is level. If not, either one of the cable distal ends 108a and 108b can be pulled in a direction away from the tilt pulley assemblies 112a and 112b, respectively, until the object 102 is level. The cable distal end 108 is then pulled towards the first direction 220 to lock the cable 106 into the stationary position. Finally, since the cable distal end 108 passes through the tilt pulley assembly 112, it pivots parallel to the mounting surface 104, concealing behind the object 102 so that the complete wall hoist assembly 100 is not visible after the object 102 is fully lifted and adjusted. To lower the object 102, each cable distal end 108 can easily be pulled out from behind the object 102. Moving each cable distal end 108 towards the second direction 222 releases the cable 106, and the weight of the object 102 is allowed to slowly be lowered, while the cable 106 slowly releases.

Another embodiment of the present invention, shown in FIGS. 9 and 10 includes a wall hoist assembly 900 for lifting, leveling, and supporting at least one object, e.g., object 102 shown in FIG. 1, on a mounting surface 104. The wall hoist assembly 100 includes a cable 901, which is defined by a cable distal end 903 for adjusting the wall hoist assembly 900. The cable 901 has a proximal end 905 for securing the cable 901 to the at least one object.

A mounting surface assembly 900 is adapted to slidably engage a cable 901 and includes a mounting aperture 902 for fastening the mounting surface assembly 900 to the mounting surface 915. The mounting surface assembly 900 further includes a substantially arched hub member 904 for slidably engaging the cable 901, where the hub member 904 includes a channel 906 (hidden in the view of FIG. 9) that allows the cable 901 to slidably pass through.

The mounting surface assembly 900 further includes a spring-biased locking member 908 for gripping and locking the cable 901 into a stationary position. The locking member 908 includes a locking aperture 910 for the cable 901 to pass through the spring-biased arm 914. In accordance with one embodiment, the locking member 908 further includes a plurality of serrated members 912 for gripping the cable 901. Because the friction of the serrated members 912, tilting the cable 901 in a first direction 920 causes the spring-biased locking member 908 to grip the cable 901. Frictional forces between the serrated members 912 and the cable 901 secure the cable 901 into the locked position shown in FIG. 10. Tilting the cable 901 in a second direction 922 with enough force to overcome the spring bias causes the locking member 908 to release the cable 901 as shown in FIG. 9. FIG. 3 shows an additional embodiment of the present invention, where a track 302 is provided as part of the wall hoist assembly. The track 302 is adapted to be mounted to and couple the opposing pair of surface mounting pulley assemblies 114a, 114b to the mounting surface. The opposing pair of surface mounting pulley assemblies 114a, 114b are slidably engaged with the track 302 and selectively horizontally positionable along the track. The object 102 can therefore, advantageously, be horizontally aligned once the assembly is attached to the mounting surface. The track 302 is also advantageous, as it provides the user with a tremendous choice of where to install mounting hardware, e.g., screws or nails, and how many to use. For example, for heavy objects, a large number of mounting hardware may be used, but for light objects, just two will suffice.

What is claimed is:

1. A wall hoist assembly comprising:
a first cable having a proximal end and a distal end separated by a first cable length;
a first tilt pulley assembly adapted to rotatably engage the first cable length, the first tilt pulley assembly including a locking member assembly operable to allow the first cable to slide in a first direction and selectively prevent the first cable from sliding in a second direction;
a first surface mounting pulley assembly adapted to fixedly adhere to a wall surface and to rotatably engage the first cable length; and
a first object mounting pulley assembly adapted to rotatably engage the first cable length and couple an object to the wall surface,
the wall hoist assembly having at least a first orientation where the object is resting on a floor surface and a second configuration where the object at least partially covers the first tilt pulley assembly, the first surface mounting pulley assembly, and the first object mounting pulley assembly, the first and second configurations being selectable by applying a pulling force to the proximal end of the first cable.

2. The wall hoist assembly according to claim 1, further comprising:
a second cable having a proximal end and a distal end separated by a second cable length;
a second tilt pulley assembly adapted to rotatably engage the second cable length, the second tilt pulley assembly including a locking member assembly operable to allow the second cable to slide in a first direction and selectively prevent the second cable from sliding in a second direction;
a second surface mounting pulley assembly adapted to fixedly adhere to the wall surface and to rotatably engage the second cable length; and
a second object mounting pulley assembly adapted to rotatably engage the second cable length and couple the object to the wall surface,
wherein, when the wall hoist assembly is in the second orientation, the object at least partially covers the second tilt pulley assembly, the second surface mounting pulley assembly, and the second object mounting pulley assembly.

3. The wall hoist assembly according to claim 1, wherein the first tilt pulley assembly further comprises:
a multi-directional tilt sheave for engaging the first cable; and
a tilt axle for rotatably engaging the tilt sheave.

4. The wall hoist assembly according to claim 3, wherein the first tilt pulley assembly further comprises:
a locking member assembly having a first support member, a second support member, and a spacer, the spacer having a spacer aperture end and a spacer locking end.

5. The wall hoist assembly according to claim 1, wherein the first tilt pulley assembly further comprises:
a tilt aperture;
a multi-directional mounting sheave for engaging the first cable; and
a mounting axle for rotatably engaging the multi-directional mounting sheave.

6. The wall hoist assembly according to claim 1, wherein the first object mounting pulley assembly further comprises:
an object aperture;
a multi-directional object sheave for engaging the first cable; and
an object axle for rotatably engaging the multi-directional object sheave.

7. The wall hoist assembly according to claim 1, further comprising:
at least one sleeve member.

8. The wall hoist assembly according to claim 1, further comprising:
a track adapted to be mounted to and couple the first surface mounting pulley assembly to the wall surface.

9. The wall hoist assembly according to claim 8, wherein the first surface mounting pulley assembly is slidably engaged with the track and selectively horizontally positionable along the track.

10. A wall hoist assembly comprising:
an opposing pair of surface mounting pulley assemblies adapted to mechanically couple to a vertical surface;
an opposing pair of object mounting pulley assemblies adapted to mechanically couple to rear surface of an object;
an opposing pair of cables, each one coupling one of the pair of surface mounting pulley assemblies to one of the opposing pair of object mounting pulley assemblies;
an opposing pair of tilt pulley assemblies, each tilt pulley assembly being coupled to one of the opposing pair of cables in a selectively slidable and selectively lockable relationship and located between one of the pair of surface mounting pulley assemblies and one of the opposing pair of object mounting pulley assemblies, wherein each of the opposing pair of tilt pulley assemblies includes a pulley system that:
translates a force applied to one of the opposing pairs of cables in a first direction into a force that moves one of the pair of surface mounting pulley assemblies in a direction toward one of the opposing pair of object mounting pulley assemblies;
translates a force applied to one of the opposing pairs of cables in a second direction into a force that moves one of the pair of surface mounting pulley assemblies in a direction away from one of the opposing pair of object mounting pulley assemblies; and
locks a respective one of the cables into a static position so that a distance between the one of the pair of surface mounting pulley assemblies and the one of the opposing pair of object mounting pulley assemblies remains fixed.

11. The wall hoist assembly according to claim 10, wherein, the object is larger than a distance between the pair of opposing surface mounting pulley assemblies when the pair of surface mounting pulley assemblies are coupled to the vertical surface so that the object hides the pair of surface mounting pulley assemblies from view.

12. The wall hoist assembly according to claim 10, wherein, the opposing pair of surface mounting pulley assemblies are adapted to be mechanically coupled to a vertical surface with at least one of a nail and a screw.

13. The wall hoist assembly according to claim 10, further comprising:
a track adapted to be mounted to and couple the opposing pair of surface mounting pulley assemblies to the vertical surface.

14. The wall hoist assembly according to claim 13, wherein the opposing pair of surface mounting pulley assemblies are slidably engaged with the track and selectively horizontally positionable along the track.

15. The wall hoist assembly according to claim 10, wherein, the object is a painting.

16. A method for mounting an object to a mounting surface, the method comprising:
providing at least two wall hoist subassemblies, each subassembly including:
a cable;
a surface mounting pulley assembly coupled to the cable;
an object mounting pulley assembly coupled to the cable; and
a tilt pulley assembly coupled to the cable between the surface mounting pulley assembly and the object mounting pulley assembly;
coupling the at least two surface mounting pulley assemblies to the mounting surface in an opposing arrangement;
coupling the at least two object mounting pulley assemblies to a rear surface of the object in an opposing arrangement; and
selectively applying a pulling force to one end of each of the at least two cables to cause the at least two object mounting pulley assemblies to move closer to the at least two surface mounting pulley assemblies.

17. The method according to claim 16, further comprising:
selectively applying a pulling force to at least one of the at least two cables to cause the object to be mounted on the mounting surface in a level position.

18. The method according to claim 16, further comprising:
coupling a track to the mounting surface;
coupling the at least two surface mounting pulley assemblies to the track; and
selectively translating the object along the mounting surface by sliding the at least two surface mounting pulley assemblies along the track.

19. The method according to claim 16, further comprising:
manipulating a locking mechanism within the tilt pulley assembly to selectively engage and hold the cable in a static position.
